(19) United States
(12) Patent Application Publication
(10) Pub. No.: US 2019/0340371 A1
(43) Pub. Date: Nov. 7, 2019

(54) System And Method For Authenticating Computer Access

(71) Applicant: Vyvyan G. Williams, Vankleek Hill (CA)

(72) Inventor: Vyvyan G. Williams, Vankleek Hill (CA)

(21) Appl. No.: 15/971,747

(22) Filed: May 4, 2018

(51) Int. Cl. G06F 21/62; H04L 29/06; G06F 21/30

(52) U.S. Cl. CPC G06F 21/62; H04L 67/02; G06F 21/305; H04L 63/083

(57) ABSTRACT

A system for authenticating computer access includes a local computer having a central processing unit (CPU) and having a memory device. An authentication switch is positioned on the local computer, the switch being in data communication with the CPU and storage unit. An authentication program stored in ROM is operable to detect when an input field in the form of a password box is open on the computer and to detect if the authentication interface is actuated. The authentication program is operable to receive a password input identifier from the input box only if the authentication interface on the computer is actuated while the input box is open. A file saved in RAM on the local computer may only be accessed when the authentication button is pressed at the same time a password authorizing access to the local computer is entered.

### BACKGROUND OF THE INVENTION

This invention relates to access security systems for computer systems and, more particularly, to a system and method for controlling access to a local computer's stored data by requiring that an authentication switch on the local computer be engaged before and while a user enters a password into a pop-up input field—which may be referred to herein and perhaps better understood to a layperson as a password box.

An unauthorized person may observe a computer owner entering his password into his personal computer and then use that password at a later time to access stored data on the personal computer. Further, sophisticated computer programs are sometimes used from remote computers to guess or decipher a person's password and access personal data from the victim's computer via the internet. Still further, a hacker may sponsor a website and collect passwords from users or clients who sign up for access to the sponsored. Thereafter, the hacker uses the passwords to access the victim's local computer via internet access.

Various systems have been proposed in the art to protect against the breach and theft of one's data stored on an electronic device or “in the cloud” such as encryption, dual password protection, and even the so-called “Bitcoin” paradigm. Although presumably effective for their intended purposes, such methods still suffer from the problem of a person's passwords being seen and later used without permission to access a local computer.

Therefore, it would be desirable to have a system for authenticating computer access in which a computer is manufactured with a specialty button referred to herein as an “authentication switch” or “security button” that must be pressed simultaneously with entry of a password before access to any saved data is accessible on the local computer. Further, it would be desirable to have a system for authenticating computer access that prohibits access of files stored on a local computer by a remote computer attempting to access the local computer via the internet.

### SUMMARY OF THE INVENTION

A system and method for authenticating computer access according to the present invention includes a local computer having a central processing unit (CPU) and having a memory device that includes, as is well-known to one of ordinary skill in the art, a read-only-memory (ROM) and a random-access memory (RAM) portion. An authentication switch is positioned on the local computer, the switch being in data communication with the CPU and storage unit. An authentication program stored in ROM is operable to detect when an input field is open on the computer and to detect if the authentication interface is actuated. The authentication program is operable to receive a password input identifier from the input field only if the authentication interface on the computer is actuated while the input field is open. A file saved in RAM on the local computer may only be accessed when the authentication button is pressed at the same time a password authorizing access to the local computer, i.e. a file RAM, is entered.

Therefore, a general object of this invention is to provide a system and method for authenticating computer access for granting access to a computer's saved data and files only if a tangible authentication button is depressed simultaneously with the input of a password.

Another object of this invention is to provide a system and method for authenticating computer access, as aforesaid, having an authentication program stored in memory of the local computer that is operable to detect when an input field is open on the display and when an authentication switch is depressed.

Still another object of this invention is to provide a system and method for authenticating computer access, as aforesaid, having an override switch for turning off the authentication switch requirement.

Yet another object of this invention is to provide a system and method for authenticating computer access, as aforesaid, that prevents remote computers from accessing the data saved on a computer having the authentication switch and authentication program.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a local computer of the system for authenticating computer access according to the present invention;

FIG. 2 is a flowchart of a method carried out by an authenticating program according to the system of FIG. 1;

FIG. 3 is a block diagram of the system according to the present invention; and

FIG. 4 is a plan view according to the present invention.

### DESCRIPTION OF THE PREFERRED EMBODIMENT

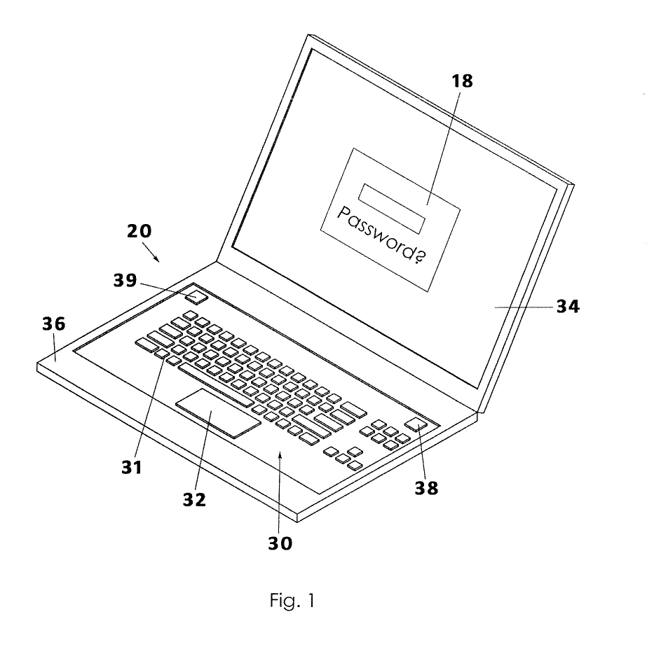

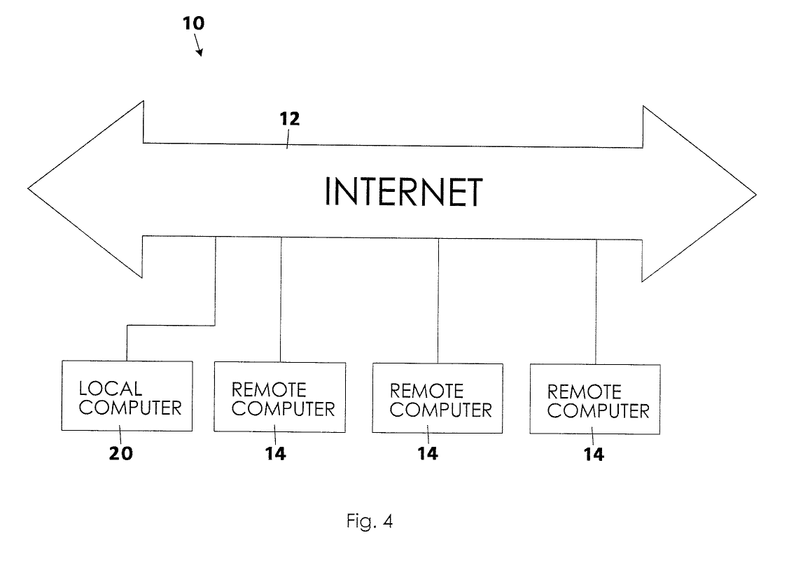

A system and method for authenticating computer access to the contents of memory of a local computer will now be described in detail with reference to FIGS. 1 to 4 of the accompanying drawings. The system for authenticating computer access 10 includes a local computer 20 that is electrically connected to a network such as the internet 12, the local computer 20 having a special purpose authentication switch, an override switch 39, and an authentication program 16 that runs in the background or integrally with the operating system on the local computer 20.

The local computer 20 referenced in the present invention may be a laptop, tablet, tower, workstation, server, smart phone, or other electronic device that may be connected to a wide area network such as the internet 12, a local network such as an intranet, or any other electronic device. Further, the local computer 20 has at least a central processing unit, which may also be referred to simply as a processor 22 or a “CPU”, a non-volatile memory 24 having a read-only memory (“ROM”) 26, a random access memory (RAM) 28 being in data communication with a non-volatile storage unit (also referred to simply as memory), an input device 30 such as a keyboard 31 or mouse or track-pad 32, and a digital display 34 capable of displaying text or graphics. It is understood that programs that boot-up, read from and control computer buttons, or control fundamental computer functions may be stored in the read-only-memory (ROM) and be stored thereon at the point of manufacture. In some instances, however, the next higher level functions, such as file management, a graphic user interface (“GUI”), and control of peripheral devices may be referred to as the “operating system” and may be stored in the random-access-memory (“RAM”). The aforesaid program and peripheral control devices may be capable of being uninstalled, replaced, or written over although appearing to the novice to be permanently stored.

The local computer 20 may include a casing 36 configured to contain, surround, or otherwise provide a platform or framework for the keyboard, input buttons, flat touch pad 32, and the like. In addition to the usual computer keys and control buttons, the local computer 20 according to the present invention includes an authentication switch 38. Preferably, the authentication switch 38 is in the form of a specialty button extending upwardly from a front panel of the casing 36 although in some embodiments the authentication switch 38 may be a compressible button extending outwardly from a side edge of the casing 36. Like other input buttons, the authentication switch 38 may be compressible and spring activated to return naturally to an outwardly extending configuration when pressure thereon is removed by a user. Preferably, the authentication switch 38 is in data communication with the processor 22 and with the memory 24. In an embodiment, the authentication switch may be one of the keys normally found on a computer keyboard that is re-assigned and programmed to have the functionality described in this application.

An authentication program 16 is stored as software or program steps in one of the ROM or RAM memory components of the local computer 20. For instance, the programming or circuitry of ROM-type memory may be operable via the authentication program 16 to detect when the authentication program 16 is activated and the detection thereof may be communicated to the processor. Further, the authentication program 16 is also operable to detect when an input field 18 is open or has just been opened on the display screen of an electronic display 34 viewable by a user. It is understood, of course, that the authentication program 16 may be stored in RAM and, as a result, may be selectively installed or uninstalled by the user but, when installed and running, is operable both to detect an actuation of the authentication switch 38 and to detect when an input field 18 is open and awaiting input of a password. The authentication program 16 may be operable when the computer is booted up or at a time specified by a user and may be integrated into code of the operating system.

The operation of the authentication switch 38 of the local computer 20 and detection of the input field 18 is critical to operation of the present invention. More particularly and except as described otherwise later, the authentication program 16 is operable such that an open input field is allowed to receive a password from a user input device only when the authentication switch 38 is being pressed (actuated) simultaneously with actuation of the authentication switch 38 or within a predetermined time interval thereof. In other words, the authentication switch 38 need only be depressed for an instant and then the processor 22, under the control of the authentication program 16, is operable (such as in association with a counter) to count a predetermined number of seconds for a user to use an input device to enter a password into the input field 18.

There are several instances in which an input field 18 may be caused to pop up on the display 34 of the local computer 20 and solicit entry of a password before files stored in the memory of the local computer 20 may be accessed. For instance, the user of the local computer 20 may be using its connection and interface to a network, e.g. to the internet, to essentially access another computer server (a “remote computer”) and, consequently, the remote computer 14, via its website, may cause an input field 18 to pop up on the local computer 20 and to require a password before access to the remote computer 14 is permitted.

For the sake of clarity, the local computer 20 may be connected to a wide area network such as the internet 12 such that access is obtained to data stored on other connected computers using the information system known by those of ordinary skill in the art as the world wide web and the the system of standardized tags associated therewith that are referred to as hypertext markup language (“HTML”).

Conversely, one of the remote computer 14 or the local computer 20 may cause the input field 18 to pop up on the display 34 of the local computer 20 in association with a request by the remote computer 14 to access files stored on the local computer 20. In other words, a password is required before access is permitted to files saved in memory on the local computer 20. In one case, the user himself may be attempting to access his own local computer 20 from a remote location. However, it is possible that a user with an ill motive may be attempting such access. In either case, the authentication program 16 is operable to detect the input field and the authentication switch 38. As described above, the input field 18 is enabled to receive the input of a password only if the authentication switch 38 is actuated simultaneously—potentially foiling both an unwelcomed attempted access but also that of an authorized user. It is understood that the pop up input field 18 may be caused to pop up by the remote computer 14 requesting access or by the local computer 20 as a safety requirement before access is granted.

Still further, the local computer 20 is operable to pop up an input field 18 on the display of the local computer 20 before granting access to files/data stored in RAM of the local computer 20. In other words, a user may have set up the local computer 20 to require a password before allowing access to the desktop or to stored documents. Again, the authentication program 16 is operable to require that the authentication switch 38 is activated simultaneously with receiving input of the password into the input field 18 before files on the local computer 20 may be accessed.

In another aspect, the local computer 20 according to the present invention includes an override switch 39. Preferably, the override switch 39 is in the form of a specialty button extending upwardly from a front panel of the casing 36 although in some embodiments the override switch 39 may be a compressible button extending outwardly from a side edge of the casing 36. Like other input buttons, the override switch 39 may be compressible and spring activated to return naturally to an outwardly extending configuration when pressure thereon is removed by a user. Preferably, the override switch 39 is in data communication with the processor 22 and with the storage unit.

The override switch 39 is operable to counteract, override, and cause the authentication switch 38 to be deactivated. It is understood that the override switch 39 may be operable according to special circuitry in communication with the processor 22 but most likely by operation of the authentication program 16 being programmed to detect actuation of the override switch 39 in the same manner as described above for detecting actuation of the authentication switch 38. Described simply, pressing the override switch 39 causes the computer to operate as a traditional computer not requiring simultaneous operation of an authentication switch 38 and input of a password into an input field.

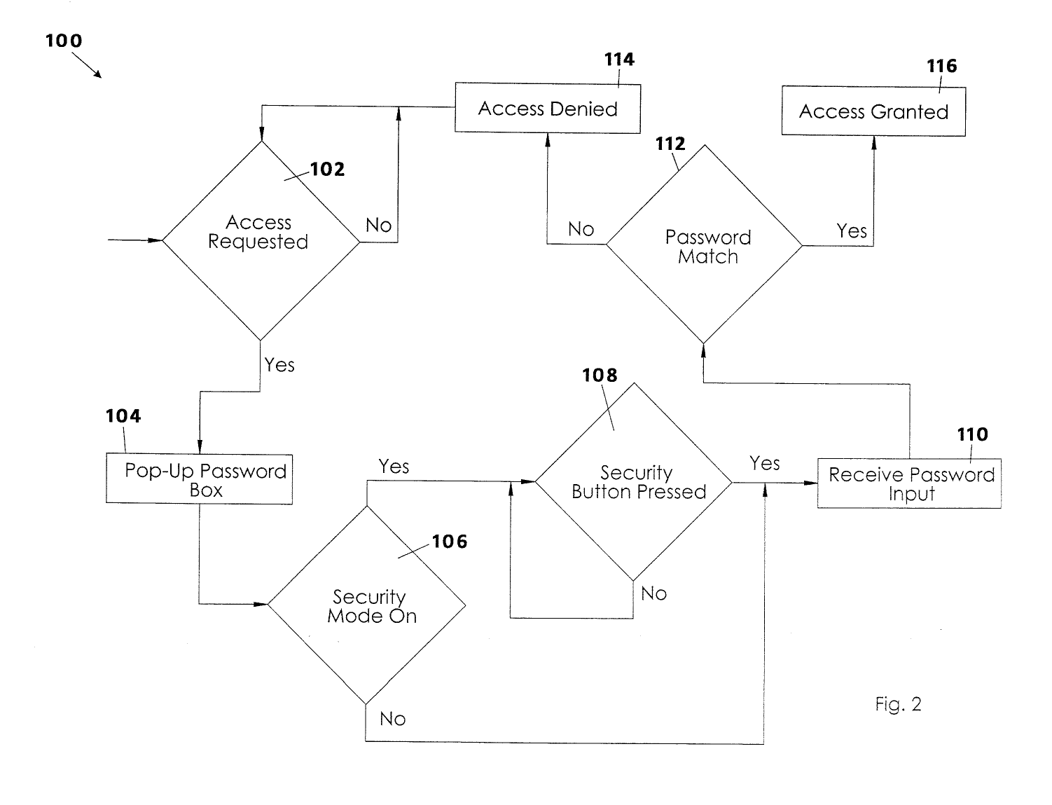

A process 100 and methodology for authenticating computer access is illustrated in FIG. 2. The process 100 beings at step 102 where the processor 22 determines if access is being requested (either by the local computer itself or by a remote computer 14 via a network) and, if so, proceeds to step 104 where an input field 18 is popped up onto the display 34 of the local computer 20. The process 100 then proceeds to step 106.At step 106, the processor 22 determines if the security mode is activated versus override activated, i.e. if the override switch 39 is being pressed. If security mode is on (i.e. override is not on), the process 100 proceeds to step 108; otherwise, the process 100 proceeds to step 110 where the password input is received by the pop up input field 18 without requiring the authentication switch 38 being pressed. In other words, when the security mode has been bypassed, the authentication switch 38 is not required before the password may be entered.

At step 108, the processor 22 determines if the authentication switch 38 is being actuated and, if so, proceeds to step 110 where the password may be entered into the input field. In other words, the condition is met that the authentication switch 38 is pressed and has not been canceled by the override switch 39 and the input field is waiting to received the password.

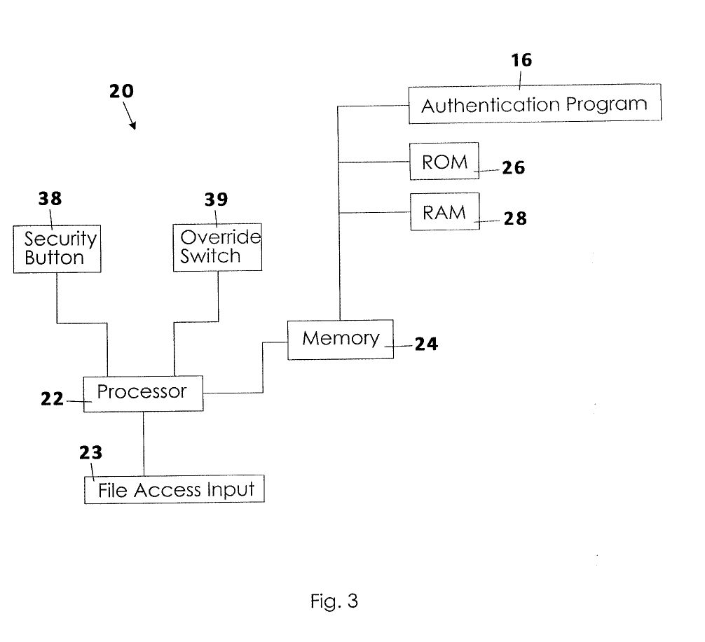

After the password is received by the input field, it is transferred to the processor 22 at step 112 to determine if it matches the predetermined or set password to enable access. If so, the process 100 proceeds to step 114 where access to the files saved on the local computer 20 may be allowed, such as indicated at the block labeled File Access Input 23 on FIG. 3. Otherwise, access is denied at step 116 and the process 100 is ended and can begin again when access is again requested as described above.

It is understood that while certain forms of this invention have been illustrated and described, it is not limited thereto except insofar as such limitations are included in the following claims and allowable functional equivalents thereof.

1. A system for authenticating computer access, the system comprising a local computer having:
a central processing unit (CPU);
a local storage unit in data communication with said CPU, said local storage unit comprising at least one of a read-only-memory (ROM) and a random-access memory (RAM);
an authentication switch in data communication with said CPU, said authentication switch being movable between a dormant configuration and an actuated configuration; and
an authentication program for granting or denying access to a secured storage unit in association with an authentication event, the secured storage unit being configured to store data,
wherein said authentication program is operable to detect when an input field in the form of a password box is open on a display screen of said local computer, the input field being configured to display a plurality of markers associated with the authentication event, each marker being associated with a character of a password input identifier,
wherein said authentication program is operable to determine whether said authentication switch is in the actuated configuration or the dormant configuration, and
wherein the authentication event comprises said input field receiving a character of the password input identifier only if said authentication switch is in the actuated configuration when the authentication program receives the character.

2. The system as in claim 1, wherein said secured storage unit is a remote storage unit associated with a remote computer, said local computer being in data communication with said remote computer via a network connection, wherein the local computer includes a plurality of input keys for inputting characters of the password input identifier during the authentication event.

3. The system as in claim 1, wherein said local storage unit comprises said secured storage unit, said local computer being in data communication with a remote computer via a network connection, wherein said local computer receives at least some of the characters of the password input identifier from the remote computer in association with a request for access to said secured storage unit of said local computer.

4. The system as in claim 1, wherein said local storage unit comprises said secured storage unit, said local computer being electronically connected to a network, wherein said local computer receives at least some characters of the password input identifier from the network in association with a request for access to said secured storage unit of said local computer.

5. The system as in claim 4, wherein said local computer further comprises an override switch in data communication with said CPU, wherein toggling of said override switch causes the local computer to toggle between a first configuration and a second configuration, wherein access to the secured storage unit being controlled by the authentication program when the local computer is in the first configuration, and wherein access to the secured storage unit is independent of the authentication program when the local computer is in the second configuration.

6. The system as in claim 1, wherein said authentication switch is a button extending through a casing of said local computer, said button being movable between a actuated position associated with the actuated configuration of the authentication switch and an extended configuration associated with the dormant configuration of the authentication switch.

7. The system as in claim 6, wherein said button is spring-loaded and normally biased toward said extended configuration.

8. The system as in claim 1, wherein said authentication program includes programming that is automatically executed when said local computer is powered up.

9. The system as in claim 8, wherein said authentication program is part of an operating system installed on said local computer.

10. The system as in claim 9, wherein said input field is produced by a graphical user interface (GUI) that is a component of said operating system.

11-20. (canceled)
